(19) United States
(12) Patent Application Publication
(10) Pub. No.: US 2007/0214695 A1
(43) Pub. Date: Sep. 20, 2007

(54) LOCK OUT TAG

(75) Inventors: Carl Frank, Mount Pleasant, IA (US); Jerry Saltzman, Morning Sun, IA (US); Jason Bender, Mount Pleasant, IA (US)

Correspondence Address: ZARLEY LAW FIRM P.L.C., CAPITAL SQUARE, 400 LOCUST, SUITE 200, DES MOINES, IA, 50309-2350, US

(73) Assignee: LOMONT MOLDING, INC., d.b.a. PARAGON PRODUCTS, Mount Pleasant, IA (US)

(21) Appl. No.: 11/277,007

(22) Filed: Mar. 20, 2006

(51) Int. Cl. G09F 3/14

(52) U.S. Cl. 40/664

(57) ABSTRACT

A tag has an in-mold graphic plate portion with a slot therein. Extending outwardly from the plate portion is an extension or tongue that has a neck and locking tip. The locking tip has an aperture adapted to receive a lock. The neck of the tongue is flexible such that the locking tip is received by and extends through the slot.

### BACKGROUND OF THE INVENTION

This invention is directed toward a tag, and more specifically a lock out tag for complying with OSHA regulations.

Lock out tags are known in the art to provide notice and authorization to specific individuals permitting removal of a lock from a secured area, such as an electrical switch/breaker box. Standard lock out tags are sold having separate pieces. Presently, a need exists for an all-in-one tag having a strap that conveniently receives a loc and provides an in-mold graphic.

An object of the present invention is to provide a tag that is easy to use.

A further object of the present invention is to provide a tag that is economical to manufacture.

These and other objects will be apparent to those skilled in the art based on the following written description.

### BRIEF SUMMARY OF THE INVENTION

A tag has an in-mold graphic plate portion with a slot therein. Extending outwardly from the plate portion is an extension or tongue that has a neck and locking tip. The locking tip has an aperture adapted to receive a lock. The neck of the tongue is flexible such that the locking tip is received by and extends through the slot.

### BRIEF DESCRIPTION OF THE DRAWINGS

FIG. 1 is a perspective view of a tag and a lock; and

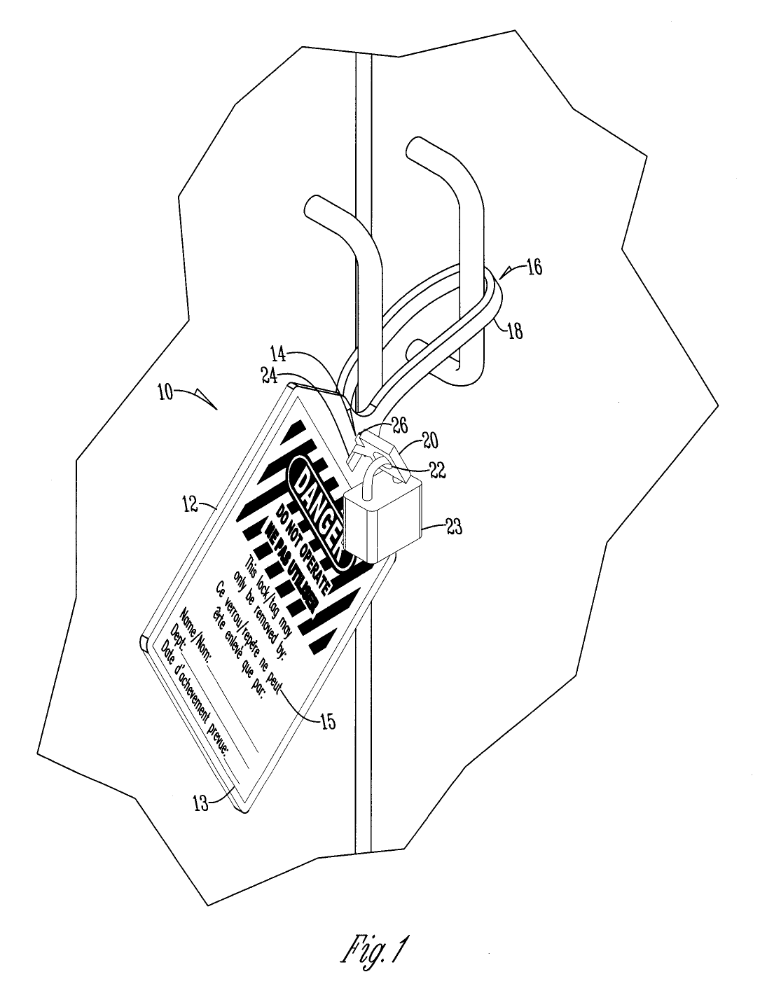

FIG. 2 is a top plan view of a tag.

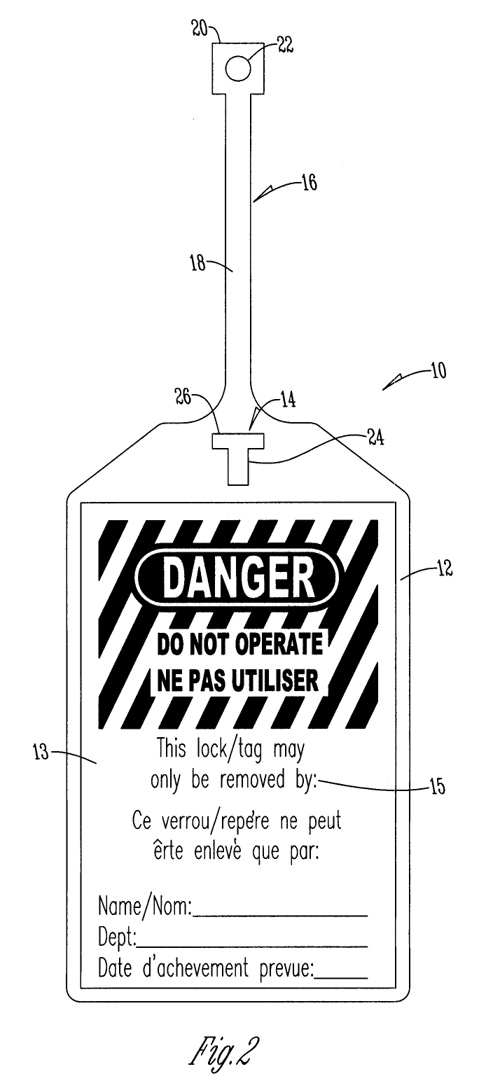

### DETAILED DESCRIPTION OF THE PREFERRED EMBODIMENT

Referring to the figures, a tag 10 has a plate portion 12. Molded within the plate portion 12 is a sheet 13 having a graphics and printed indicia 15. The graphics and indicia 15 may include a warning as well as information indicating the individual authorized to remove the tag 10.

Extending through the plate 12 is a slot 14. While the slot is of any shape and size, preferred is a T-shaped slot. Extending outwardly from the plate portion 12 is an extension or tongue 16. The tongue 16 has a neck portion 18 and a locking tip 20. The locking tip 20 is formed to be received within the slot 14 such that once the tip 20 passes through the slot and is twisted the tip 20 is retained by the tip 20 engaging a surface of the plate portion 12. The neck 18 is made of a flexible material such that the neck 18 may be bent to permit the tip 20 to be received by and pass through the slot 14. The locking tip 20 has an aperture 22 adapted to receive a lock 23, such as a conventional padlock.

In use, a tag 10 is provided and the tongue 16 is bent around an object so that the locking tip 20 is received by and passes through the slot 14. In the embodiment shown in the drawings, the neck 18 is bent and twisted such that the tip 20 slides through the narrow section 24 of the T-shaped slot 14. Once through the slot 14, when the neck 18 is permitted to untwist, the neck 18 is received in the transverse section 26 of the slot 14, such that an edge of the tip engages a surface of the plate portion 12. Once the tip 20 is retained, the lock 23 is inserted through aperture 22 and locked in place.

From the foregoing, a tag has been shown that meets at least all the state objectives.

1. a tag, comprising:
an in-mold plastic plate portion having a slot;
a flexible tongue having a neck portion that extends outwardly from the plate portion and has a locking tip extending from the neck portion; and
the locking tip formed to be received by the slot and having an aperture adapted to receive a lock;
wherein once the locking tip passes through the slot and is twisted the locking tip is retained by a surface of the plate portion.

2. The tag of claim 1 wherein the slot is T-shaped.

3. the tag of claim 1 wherein the in-mold plastic plate portion has a graphic sheet.
